(19) United States
(12) Patent Application Publication
(10) Pub. No.: US 2020/0030180 A1
(43) Pub. Date: Jan. 30, 2020

(54) FOAM ROLLER FOR YOGA

(71) Applicant: ASIA REGENT CORPORATION, Taichung City (TW)

(72) Inventor: YI-HUNG LIN, Taichung City (TW)

(21) Appl. No.: 16/049,566

(22) Filed: Jul. 30, 2018

(51) Int. Cl. A61H 15/00; A63B 22/20

(52) U.S. Cl. CPC A61H 15/0092; A63B 22/20; A61H 2015/0014; A61H 2201/1253; A61H 2201/169

(57) ABSTRACT

A foam roller includes a tube and a pad. The tube is made of an elastic material and formed with an external face and an internal face. The external face of the tube includes alternately arranged facets and angles. The pad is made of a relatively soft and elastic material and formed on the external face of the tube. The pad includes facets and angles corresponding to the facets and angles of the tube.

### BACKGROUND OF INVENTION

### 1. Field of Invention

The present invention relates to an exercise device for yoga and, more particularly, to a foam roller for yoga.

### 2. Related Prior Art

Yoga is a popular exercise taken by many people to increase the flexibility of their bodies. In yoga, a foam roller is often used for massage of a user's lower legs, upper legs, waist, hips, neck and back.

As disclosed in Taiwanese Patent M369777, a conventional foam column includes a tunnel extending throughout an axis thereof. Tunnel increases an extent to which the foam column is deformed under compression. However, due to the material of the foam column and the tunnel made in the foam column, the deformation of the foam column could be too much to allow the user to do yoga with the foam column.

As disclosed in Taiwanese Patents M405881 and M485060, a conventional foam roller includes a tube covered by a pad. Massaging portions are provided on an external face of the pad. The massaging portions are bosses or ribs for contacting and massaging a user and, more particularly, for stimulating meridians, lymphatic glands and acupunctures.

However, each of the conventional foam column and the conventional roller provides a substantially consistent degree of hardness (or flexibility) over the entire external face thereof. Hence, none of the conventional foam column and the conventional roller provides different intensities of massage on different users or different body parts of a user.

The present invention is therefore intended to obviate or at least alleviate the problems encountered in prior art.

### SUMMARY OF INVENTION

It is an objective of the present invention to provide a foam roller with various portions to provide different degrees of hardness to provide different degrees of massage of users.

It is another objective of the present invention to provide a foam roller that provides pauses in rolling to provide an intermittent movement on a user's body to improve the effect of the massage.

To achieve the foregoing objectives, the foam roller includes a tube and a pad. The tube is made of an elastic material and formed with an external face and an internal face. The external face of the tube includes alternately arranged facets and angles. The pad is made of a relatively soft and elastic material and formed on the external face of the tube. The pad includes facets and angles corresponding to the facets and angles of the tube.

Other objectives, advantages and features of the present invention will be apparent from the following description referring to the attached drawings.

### BRIEF DESCRIPTION OF DRAWINGS

The present invention will be described via detailed illustration of three embodiments referring to the drawings wherein:

FIG. 1 is a perspective view of a foam roller according to the first embodiment of the present invention;

FIG. 2 is an enlarged partial cut-away view of the foam roller shown in FIG. 1;

FIG. 3 is a cross-sectional view of the foam roller shown in FIG. 1;

FIG. 4 is another cross-sectional view of the foam roller of FIG. 1;

FIG. 5 is a perspective view of a user using the foam roller shown in FIG. 1;

FIG. 6 is an enlarged partial side view of the user using a portion of the foam roller shown in FIG. 5;

FIG. 7 is an enlarged partial view of the user using another portion of the foam roller shown in FIG. 5;

FIG. 8 is a perspective view of a foam roller according to the second embodiment of the present invention;

FIG. 9 is an enlarged partial cut-away view of the foam roller shown in FIG. 8;

FIG. 10 is an exploded view of a tube of the foam roller;

FIG. 11 is a cross-sectional view of the tube shown in FIG. 10;

FIG. 12 is a cross-sectional view of a tube according to the third embodiment of the present invention;

FIG. 13 is a perspective view of a user using the foam roller shown in

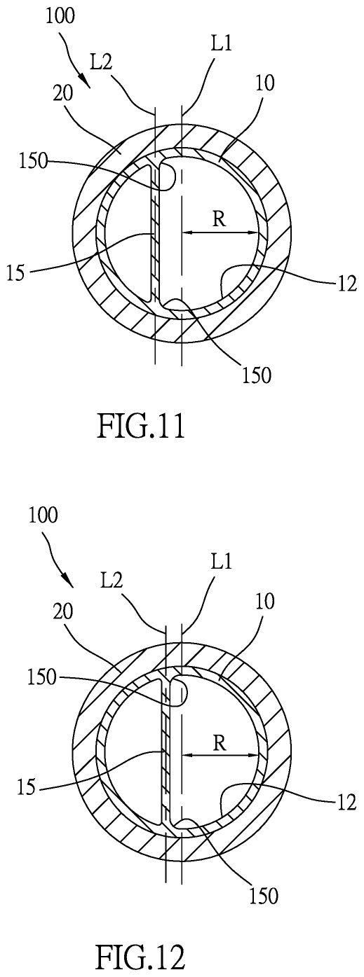

FIG. 11;

FIG. 14 is an enlarged cross-sectional view of the foam roller of FIG. 11 deformed to an extent; and

FIG. 15 is an enlarged cross-sectional view of the foam roller of FIG. 11 deformed to another extent.

### DETAILED DESCRIPTION OF EMBODIMENTS

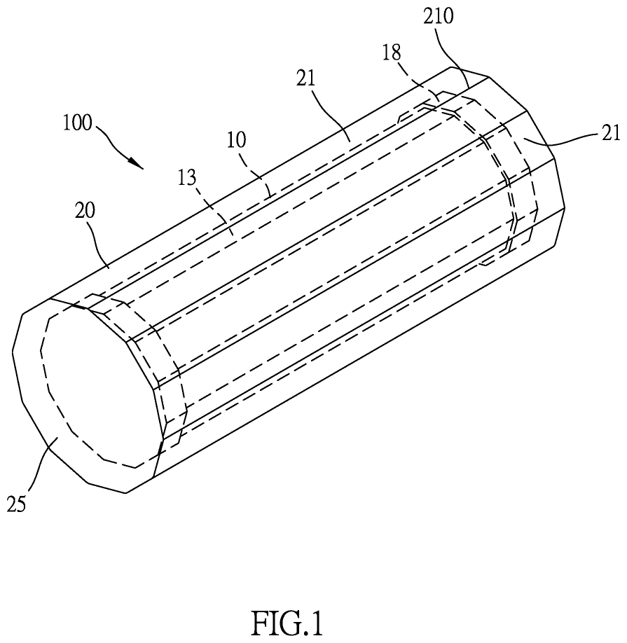

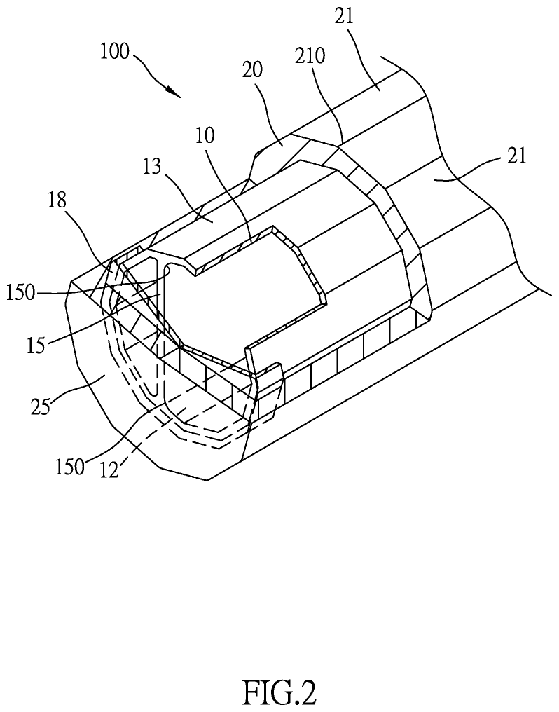

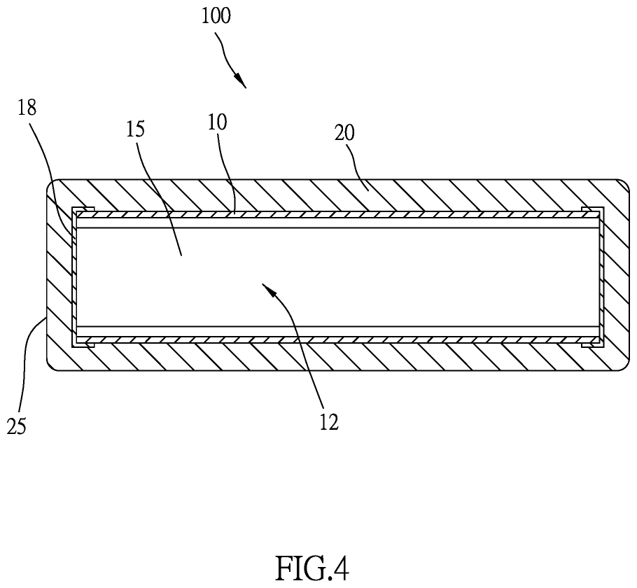

Referring to FIGS. 1 through 4, shown is a foam roller 100 for providing various intensities of massage according to a first embodiment of the present invention. The foam roller 100 includes a tube 10 wrapped by a pad 20.

The tube 10 is made of a thermoplastic material, glass fibers or carbon fibers so that the tube is deformed when a force is exerted on it and recovers when the force is removed. The tube 10 is made with an external face 11 and an internal face 12. The external face 11 includes facets 13. The internal face 12 also includes facets (not numbered) corresponding to the facets 13 of the external face 11. The external face 11 is at a constant distance from the internal face 12. That is, the distance between a facet 13 and the corresponding facet of the internal face 12 is identical to the distance of any other facet 13 from the corresponding facet of the internal face 12. The number of the facets 13 is 9, 12 or another proper number.

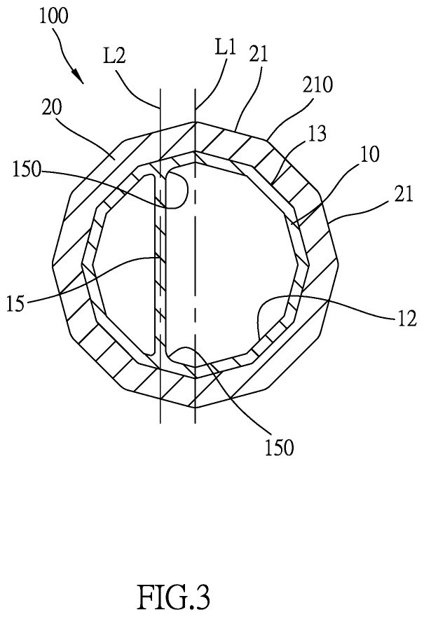

Referring to FIG. 3, the tube 10 further includes an internal plate 15 formed on the internal face 12. The internal plate 15 is connected to the internal face 12 of the tube 10 at two connective portions 150. The connective portions 150 are larger than the remaining portion of the internal plate 15 to reinforce the connection of the internal plate 15 to the internal face 12. The thickness of the internal plate 15 is 0.8 to 1.2 times as large as the distance between the external face 11 and the internal face 12, i.e., the distance between each facet 13 and the corresponding facet of the internal face 12. The internal plate 15 is biased from an axis of the internal face 12. In specific, the internal plate 15 extends along a central line L2. The distance between the central line L2 and a diameter L1 of the tube 10 is 0.15 to 0.70 time as large as the radius R of the internal face 12.

The tube 10 further includes two covers or plugs 18 for covering two open ends of the tube 10. The covers 18 keep the interior of the tube 10 from any material of the pad 20 when the pad 20 is molded on the tube 10.

The pad 20 is made of a soft, elastic and anti-skid material such as plastics, rubber and plastics, rubber and expanded polyethylene. The pad 20 is formed on and around the external face 11 of the tube 10 by a proper process such as hot pressing, hot melting and injection molding. The pad 20 includes facets 21 corresponding to the facets 13 of the tube 10. There is an angle or edge 210 between every two adjacent facets 21. The pad 20 includes two lateral covering portions 25 for covering the covers 18 or the open ends of the tube 10. Thus, the pad 20 wraps the entire tube 10. The thickness of the lateral covering portions 25 is about 2 to 8 times as large as the thickness of the tube 10, which is the distance between the external face 11 and internal face 12. Each of the facets 21 is planar or formed with bosses and/or ribs.

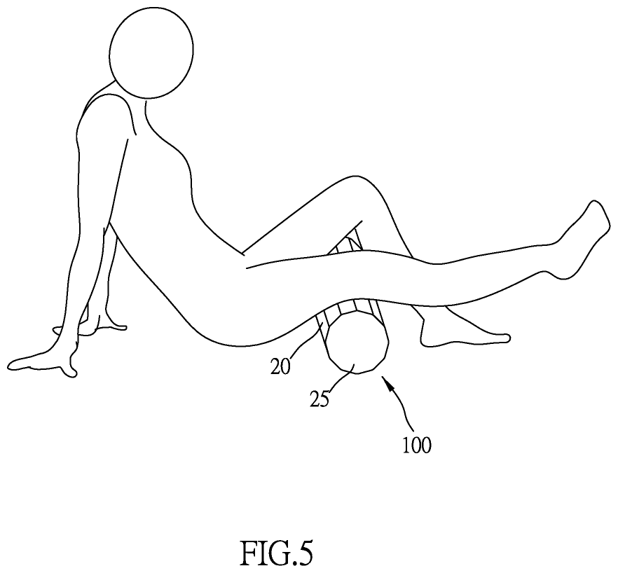

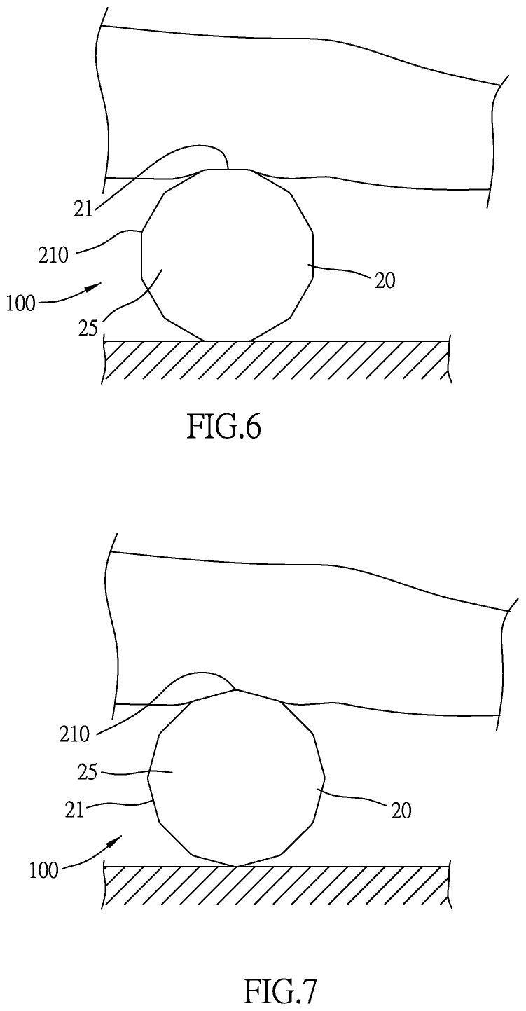

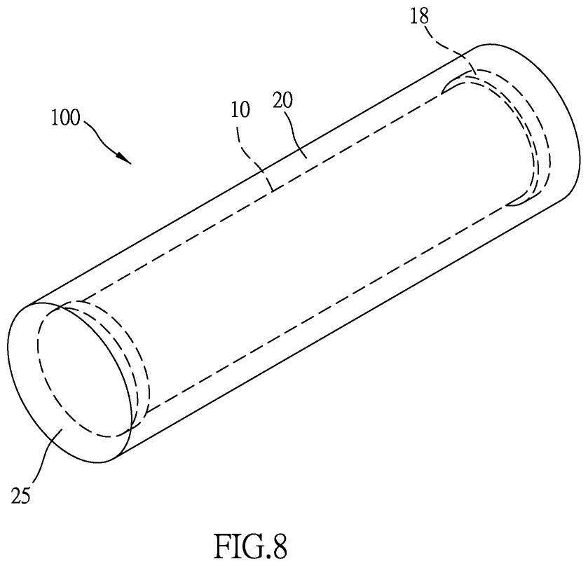

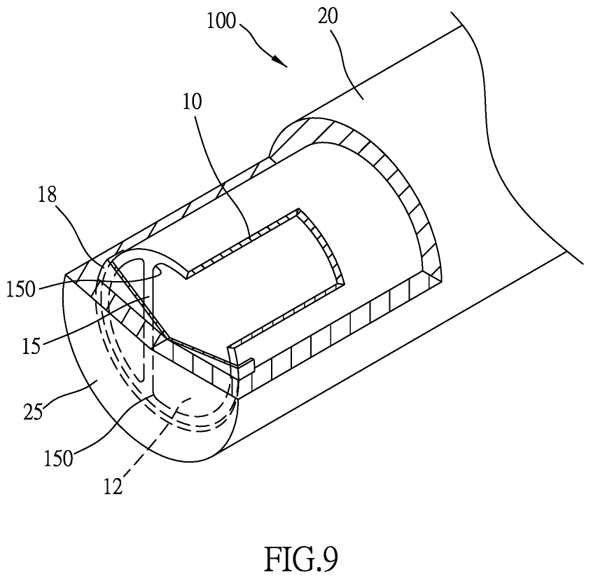

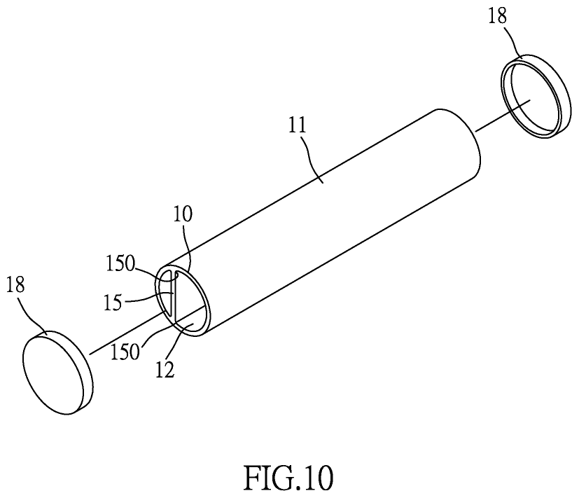

The foam roller 100 can be used in various modes referring to FIGS. 5 to 7, respectively. The user lays his or her neck, legs, back or waist on the foam roller 100 and uses his or her neck, legs, back or waist to roll the foam roller 100. Thus, the user massages his or her neck, legs, back or waist on the foam roller 100. The facets 21 and the angles 210 press the user's neck, legs, back or waist to different extents. The facets 21 and the angles 210 ensure the rolling of the foam roller 100 on a floor by avoid skid of the foam roller 100 on the floor. Moreover, the facets 21 and the angles 210 make the foam roller 100 jump while rolling. The facets 21 press the user's neck, legs, back or waist relatively mildly. The angles 210 press the user's neck, legs, back or waist relatively intensively. Thus, this alternate arrangement of mild pressing and intensive pressing provides deep massage to the muscles and nerve in the user's neck, legs, back or waist. Furthermore, the facets 21 and the angles 210 keep the foam roller 100 in position when the foam roller 100 is not used.

Referring to 8 through 11, shown is a foam roller 100 according to a second embodiment of the present invention. The second embodiment is identical to the first embodiment except for several things. Firstly, the tube 10 includes a smooth cylindrical external face 11 instead of the facets 13. Secondly, the pad 20 includes a smooth cylindrical external face instead of the facets 21.

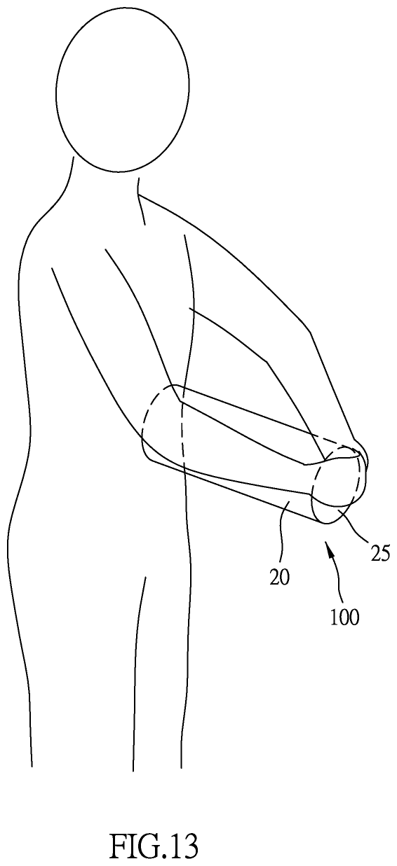

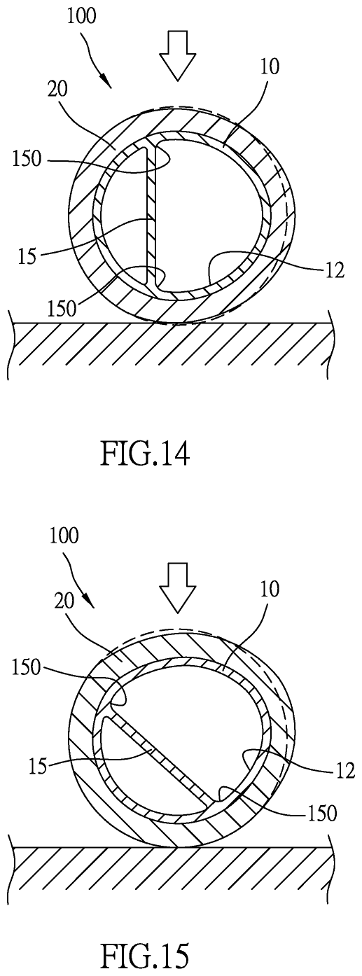

Referring to FIG. 13, in use, the user uses an end of the foam roller 100 to press a portion of his or her body.

Referring to FIGS. 14 and 15, the internal plate 15 is located vertically. Thus, the foam roller 100 provides the user with a relatively hard touch.

Referring to FIGS. 14 and 15, the internal plate 15 is removed from the vertical position. Now, the foam roller 100 provides the user with a relatively soft touch. The foam roller 100 provides the user with a softest touch when the internal plate 15 is located horizontally.

Referring to FIG. 12, shown is a foam roller 100 according to a third embodiment of the present invention. The third embodiment is identical to the second embodiment except for that the distance between the central line L2 and the diameter L1 of the tube 10 is smaller.

The present invention has been described via the illustration of the embodiments. Those skilled in the art can derive variations from the embodiments without departing from the scope of the present invention. Therefore, the embodiments shall not limit the scope of the present invention defined in the claims.

1. A foam roller comprising:
a tube (10) made of an elastic material and formed with an external face (11) and an internal face (12), wherein the external face (11) of the tube (10) comprises alternately arranged facets (13) and angles; and
a pad (20) made of a relatively soft and elastic material and formed on the external face (11) of the tube (10), wherein the pad (20) comprises facets (21) and angles (210) corresponding to the facets (13) and angles of the tube (10).

2. The foam roller according to claim 1, wherein the tube (10) comprises an internal plate (15) formed on the internal face (12), wherein the internal plate (15) extends along a central line (L2) at a distance from a diameter (L1) of the internal face (12) of the tube (10), wherein the distance is 0.15 to 0.70 as large as a radius of the internal face (12) of the tube (10).

3. The foam roller according to claim 1, wherein the tube (10) comprises two open ends, wherein the pad (20) comprises two lateral covering portions (25) for covering the open ends of the tube (10).

4. The foam roller according to claim 3, comprising two covers (18) for covering the open ends of the tube (10) to keep the material of the pad (20) out of the tube (10) during the making of the pad (20).

5. A foam roller comprising:
a tube (10) made of an elastic material and formed with a smooth cylindrical external face (11) and an internal face (12); and
a pad (20) made of a relatively soft and elastic material and formed on the external face (11) of the tube (10), wherein the pad (20) comprises a smooth cylindrical external face.

6. A foam roller comprising:
a tube (10) made of an elastic material and formed with an external face (11), an internal face (12), and internal plate (15) formed on the internal face (12), wherein the internal plate (15) extends along a central line (L2) at a distance from a diameter (L1) of the internal face (12) of the tube (10), wherein the distance is 0.15 to 0.70 as large as a radius of the internal face (12) of the tube (10); and
a pad (20) made of a relatively soft and elastic material and formed on the external face (11) of the tube (10).

7. The foam roller according to claim 6, wherein the external face (11) of the tube (10) comprises alternately arranged facets (13) and angles, wherein the pad (20) comprises facets (21) and angles (210) corresponding to the facets (13) and angles of the tube (10).

8. The foam roller according to claim 6, wherein the tube (10) comprises two open ends, wherein the pad (20) comprises two lateral covering portions (25) for covering the open ends of the tube (10).

9. The foam roller according to claim 8, comprising two covers (18) for covering the open ends of the tube (10) to keep the material of the pad (20) out of the tube (10) during the making of the pad (20).

10. The foam roller according to claim 6, wherein the external face (11) of the tube (10) is a smooth cylindrical external face (11), wherein the external face of the pad (20) is a smooth cylindrical external face.
